(19) United States
(12) Patent Application Publication
(10) Pub. No.: US 2015/0212824 A1
(43) Pub. Date: Jul. 30, 2015

(54) BOOTING A MACHINE USING A FIRMWARE FILE SYSTEM

(71) Applicant: Google Inc., Mountain View, CA (US)

(72) Inventor: Stefan REINAUER, Mountain View, CA (US)

(73) Assignee: Google Inc., Mountain View, CA (US)

(21) Appl. No.: 13/739,951

(22) Filed: Jan. 11, 2013

Related U.S. Application Data
(60) Provisional application No. 61/608,067, filed on Mar. 7, 2012.

(51) Int. Cl. G06F 9/44

(52) U.S. Cl. CPC G06F 9/4401

(57) ABSTRACT

Systems and methods for booting a machine are provided. In some aspect, a system includes a boot manager configured to manage the initialization of at least one hardware component of the machine based on an execution path. The system also includes a file system including open-source modules and proprietary modules. The boot manager is further configured to select a first one of the open-source modules or a first one of the proprietary modules to be executed based on the execution path. The boot manager is further configured to make a second selection of a second one of the open-source modules or a second one of the proprietary modules to be executed based on the execution path. The execution path includes execution of at least one open-source module and at least one proprietary module.

### CROSS REFERENCE TO RELATED APPLICATION

This application claims priority under 35 U.S.C. §119(e) and the benefit of U.S. Provisional Application No. 61/608,067, filed Mar. 7, 2012, and entitled, “BOOTING A MACHINE USING A FIRMWARE FILE SYSTEM,” the entire disclosure of which is incorporated herein by reference.

### FIELD

The subject technology generally relates to booting a machine and, in particular, relates to booting a machine using a firmware file system.

### BACKGROUND

Developers often have to choose between using proprietary firmware and open-source firmware in booting a machine. Oftentimes, developers may not wish to disclose the source code of proprietary firmware due to a restrictive license agreement or due to the developer's own desire not to make public the source code of the proprietary firmware. Furthermore, modification of the proprietary firmware may be technically difficult or expensive due to the unique skills or knowledge of the developer of the proprietary firmware. Open-source firmware implementations may allow developers to take and modify firmware code in order to increase boot speed, reduce the memory required to store the code, optimize battery usage, or perform some other optimization or customization of the firmware implementation. However, open-source firmware to initialize certain hardware components may not exist and developing the firmware may be difficult and time consuming. Modifying open-source firmware to work in conjunction with proprietary firmware may be burdensome because the open-source firmware may need to comply with an open-source license agreement that may require disclosure of the source code for any modifications made to the open-source firmware, potentially violating the restrictive license agreement of the proprietary firmware or compelling the public release of proprietary code.

### SUMMARY

The disclosed subject matter relates to a system for booting a machine. The system includes a boot manager configured to manage the initialization of at least one hardware component of the machine based on an execution path. The system also includes a file system including one or more open-source modules and one or more proprietary modules. The boot manager is further configured to make a first selection of a first one of the one or more open-source modules or a first one of the one or more proprietary modules to be executed based on the execution path and, upon completion of execution of the first selection, the boot manager is further configured to make a second selection of a second one of the one or more open-source modules or a second one of the one or more proprietary modules to be executed based on the execution path. The one or more open-source modules do not select the one or more the proprietary modules to be executed and the one or more open-source modules do not provide data to the one or more proprietary modules to be executed. The one or more proprietary modules do not select the one or more open-source modules to be executed and the one or more proprietary modules do not provide data to the one or more open-source modules to be executed. The execution path includes execution of at least one open-source module and at least one proprietary module.

The disclosed subject matter further relates to a machine-implemented method for booting a machine. The method includes selecting a first open-source module from among a set of open-source modules stored within the machine or a first proprietary module from among a set of proprietary modules stored within the machine to be executed based on an execution path associated with booting the machine. The method also includes, upon completing execution of the first open-source module or the first proprietary module, selecting a second open-source module from among the set of open-source modules or a second proprietary module from among the set of proprietary modules to be executed based on the execution path. The method also includes completing booting the machine according to the execution path. The set of open-source modules do not select proprietary modules from among the set of proprietary modules to be executed and do not provide data to the proprietary modules. The set of proprietary modules do not select open-source modules from among the set of open-source modules to be executed and do not provide data to the open-source modules. The execution path includes execution of at least one open-source module from among the set of open-source modules and the execution path includes execution of at least one proprietary module from among the set of proprietary modules.

The disclosed subject matter further relates to a machine-readable medium. The machine-readable medium includes instructions that, when executed by a machine, cause the machine to implement a method for booting the machine. The instructions include code for making a first selection for execution, based on an execution path associated with booting the machine, of a first open-source module from among a set of open-source modules stored within a file system of the machine or a first proprietary module from among a set of proprietary modules stored within the file system of the machine. The instructions also include code for causing execution of the first open-source module or the first proprietary module based on the first selection. The instructions also include code for, upon completing causing execution of the first open-source module or the first proprietary module, making a second selection for execution, based on the execution path associated with booting the machine, of a second open-source module from among the set of open-source modules or a second proprietary module from among the set of proprietary modules. The instructions also include code for causing execution of the second open-source module or the second proprietary module based on the second selection. The instructions also include code for completing booting the machine according to the execution path. The set of open-source modules do not select proprietary modules from among the set of proprietary modules to be executed and do not provide data to the proprietary modules. The set of proprietary modules do not select open-source modules from among the set of open-source modules to be executed and do not provide data to the open-source modules. The execution path includes causing execution of at least one open-source module from among the set of open-source modules and the execution path includes causing execution of at least one proprietary module from among the set of proprietary modules.

It is understood that other configurations of the subject technology will become readily apparent to those skilled in the art from the following detailed description, wherein various configurations of the subject technology are shown and described by way of illustration. As will be realized, the subject technology is capable of other and different configurations and its several details are capable of modification in various other respects, all without departing from the scope of the subject technology. Accordingly, the drawings and detailed description are to be regarded as illustrative in nature and not as restrictive.

### BRIEF DESCRIPTION OF THE DRAWINGS

The features of the subject technology are set forth in the appended claims. However, for purpose of explanation, several aspects of the disclosed subject matter are set forth in the following figures.

FIG. 1 illustrates an example of a machine configured to implement booting a machine using a firmware file system.

FIG. 2 illustrates an example data flow in booting a machine using a firmware file system.

FIG. 3 illustrates an example process by which a machine may be booted using a firmware file system.

FIG. 4 conceptually illustrates an example electronic system with which some implementations of the subject technology are implemented.

### DETAILED DESCRIPTION

The detailed description set forth below is intended as a description of various configurations of the subject technology and is not intended to represent the only configurations in which the subject technology may be practiced. The appended drawings are incorporated herein and constitute a part of the detailed description. The detailed description includes specific details for the purpose of providing a thorough understanding of the subject technology. However, it will be clear and apparent to those skilled in the art that the subject technology is not limited to the specific details set forth herein and may be practiced without these specific details. In some instances, well-known structures and components are shown in block diagram form in order to avoid obscuring the concepts of the subject technology.

As illustrated above in the Background, an approach to booting a machine using both proprietary firmware and open-source firmware, without commingling the proprietary firmware with the open-source firmware, may be desirable.

The subject technology is related to booting a machine using a firmware file system with at least one open-source module and at least one proprietary module. The memory of the machine may store, among other things, a boot manager and a file system. The boot manager may be configured to manage the initialization of at least one hardware component of the machine based on an execution path. The file system may include one or more open-source modules and one or more proprietary modules. The boot manager may be further configured to make a first selection of a first one of the one or more open-source modules or a first one of the one or more proprietary modules to be executed based on the execution path and, upon completion of execution of the first selection, the boot manager may be further configured to make a second selection of a second one of the one or more open-source modules or a second one of the one or more proprietary modules to be executed based on the execution path. The one or more open-source modules may not select the one or more the proprietary modules to be executed and the one or more open-source modules may not provide data to the one or more proprietary modules to be executed. The one or more proprietary modules may not select the one or more of the open-source modules to be executed and the one or more proprietary modules may not provide data to the one or more open-source modules to be executed. The execution path may include execution of at least one open-source module and at least one proprietary module.

Advantageously, in some implementations of the subject technology, a machine may be booted using both an open-source module and a proprietary module. The proprietary module may not be modified from its original form, satisfying a restrictive license agreement that may be associated with the proprietary module. Furthermore, the open-source module may be configured not to select or provide data to the proprietary module, satisfying an open-source license that may require disclosure of the source code for any modifications made to the open-source module without violating the restrictive license agreement that may be associated with the proprietary module.

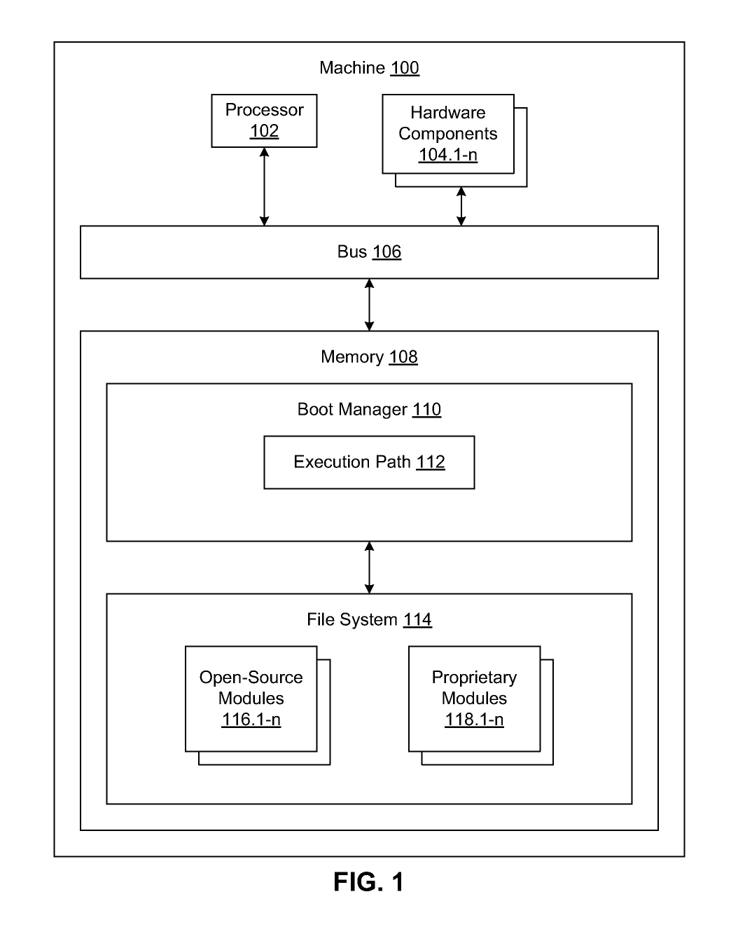

FIG. 1 illustrates an example of a machine 100 configured to implement booting a machine using a firmware file system. The machine may be a computing machine, for example, a laptop computer, a desktop computer, a tablet computer, a mobile phone, a personal digital assistant (PDA), a digital audio player including one or more processors and a memory, or a television including one or more processors and a memory. Other machines may also be used in conjunction with the subject technology.

As shown, the machine 100 includes a processor 102, hardware components 104.1-n, a bus 106, and a memory 108. The processor 102 is configured to execute computer instructions that are stored in a machine-readable medium, for example, the memory 108. The processor may be a central processing unit (CPU). The processor 102 may be an example of a hardware component in the set of hardware components 104.1-n. While only one processor 102 is illustrated in FIG. 1, the subject technology may be implemented with a machine with a single processor or in a multi-processor machine including more than one processor. The hardware components 104.1-n may include one or more of a processor (e.g., processor 102), a network interface, a disk drive, a display device, a speaker, or a microphone. The subject technology may also be implemented with other examples of hardware components. The machine 100 may include any number of hardware components 104.1-n, for example, one hardware component, two hardware components, three hardware components, or more than three hardware components. The bus 106 may be configured to transfer data or instructions between components within the machine 100. For example, the bus 106 may be configured to transfer data or instructions between the processor 102, the hardware components 104.1-n, and the memory 108. The memory 108 stores data and instructions. The memory 108 may be a non-volatile storage device, e.g., a hard disk. As illustrated, the memory 108 stores a boot manager 110 and a file system 114. While only a single memory 108 is illustrated in FIG. 1, the subject technology may be implemented in conjunction with multiple separate memory components connected to one another via a bus (e.g., bus 106).

The boot manager 110 stores instructions for booting the machine 100. As used herein, the phrase “booting the machine” encompasses its plain and ordinary meaning including but not limited to a process where the machine is turned on and prepared for normal operations, e.g., receiving and transmitting data in a network or interfacing with a user, e.g., by running applications, such as a web browser, an email client, or a word processor. As illustrated, the boot manager 110 includes an execution path 112. The execution path 112 may be a predefined execution path. Alternatively, the execution path 112 may be dynamically defined. For example, if a first hardware component fails to boot, a second hardware component, designed to perform an equivalent function, may be booted in place of the first hardware component. The execution path 112 may include a boot sequence that includes a set of operations that the machine 100 performs when the machine 100 is turned on. The execution path 112 may include instructions to initialize at least one hardware component 104.1-n on the machine 100. The execution path 112 may include instructions to execute open-source modules 116.1-n or proprietary modules 118.1-n stored in the file system 114.

In one implementation, the boot manager 110 may be configured to select for execution a first one of the open-source modules 116.1-n or the proprietary modules 118.1-n based on the execution path 112. After the first one of the open-source modules 116.1-n or the proprietary modules 118.1-n completes execution, the boot manager 110 may be configured to select for execution a second one of the open-source modules 116.1-n or the proprietary modules 118.1-n based on the execution path 112.

The file system 114 is configured to organize and retain data or instructions for the machine 100 for long-term storage, i.e., data or instructions that are stored by a machine after a program creating or modifying the data is closed or after the machine is turned off or placed in a low-power state. As illustrated, the file system 114 includes one or more open-source modules 116.1-n (e.g., a set of open-source modules 116.1-n) and one or more proprietary modules 118.1-n (e.g., a set of proprietary modules 118.1-n). As used herein, the phrase “proprietary module” encompasses its plain and ordinary meaning including but not limited to a module provided with firmware in a finished product (e.g., the machine 100 or a hardware component 104.1-n associated with the machine 100), where the code or instructions within the module are not intended to be modified or disclosed to the public. As used herein, the phrase “open-source module” encompasses its plain and ordinary meaning including but not limited to a module that requires or makes desirable disclosure of any modification to the code or instructions therein.

The open-source modules 116.1-n may be configured not to interact with the proprietary modules 118.1-n. Similarly, the proprietary modules 118.1-n may be configured not to interact with the open-source modules 116.1-n. The open-source modules 116.1-n and the proprietary modules 118.1-n may be configured not to interact with one another except via the boot manager 110. Specifically, the open-source modules 116.1-n may be configured not to select one or more proprietary modules 118.1-n to be executed and not to provide data to the one or more proprietary modules 118.1-n. Similarly, the proprietary modules 118.1-n may be configured not to select one or more open-source modules 116.1-n to be executed and not to provide data to the one or more open-source modules 116.1-n. Instead, the execution path 112 may include code or instructions for executing one or more open-source modules 116.1-n and for executing one or more proprietary modules 118.1-n. The execution path 112 may also include code or instructions for providing data to the open-source modules 116.1-n and the proprietary modules 118.1-n. It should be noted that the open-source modules 116.1-n, the proprietary modules 118.1-n, and the boot manager 110 may be separate and distinct from one another. In other words, if the open-source modules 116.1-n, the proprietary modules 118.1-n, and the boot manager 110 are implemented in software, a first block of code may include the open-source modules 116.1-n, a second block of code, different from the first block of code, may include the proprietary modules 118.1-n, and a third block of code, different from each of the first block of code and the second block of code, may include the boot manager 110.

However, the open-source modules 116.1-n may interact with one another, and the proprietary modules 118.1-n may interact with one another. Specifically, one open-source module may be configured to select an additional open-source module for execution or one open-source module may be configured to provide data to the additional open-source module. Similarly, one proprietary module may be configured to select an additional proprietary module for execution or one proprietary module may be configured to provide data to the additional proprietary module.

At least one open-source module 116.1-n may be configured to initialize a hardware component 104.1-n of the machine 100. Also, at least one proprietary module 118.1-n may be configured to initialize a hardware component 104.1-n of the machine 100. For example, a device driver of a hardware component 104.1-n may include at least one proprietary module 118.1-n.

It should be noted that while n hardware components 104.1-n, n open-source modules 116.1-n, and n proprietary modules 118.1-n are illustrated, the subject technology may be implemented with any number of hardware components, open-source modules, and proprietary modules. Specifically, there may be either the same number or a different number of each of hardware components, open-source modules, and proprietary modules.

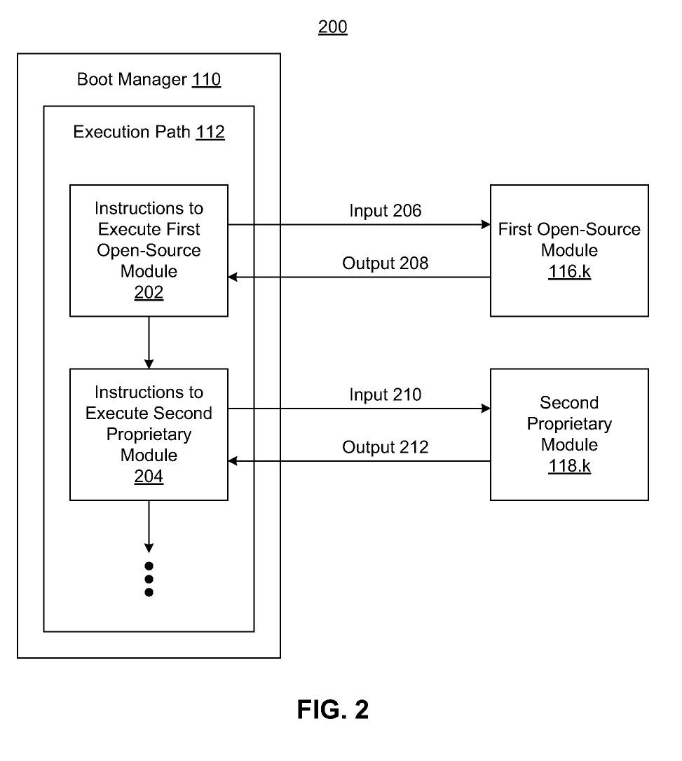

FIG. 2 illustrates an example data flow 200 in booting a machine using a firmware file system. As shown, the data flow 200 includes data being transmitted between the execution path 112 in the boot manager 110, a first open-source module 116.k from among the open-source modules 116.1-n of FIG. 1, and a second proprietary module 118.k from among the proprietary modules 118.1-n of FIG. 1.

As illustrated, the execution path 112 includes instructions 202 to execute the first open-source module 116.k and instructions 204 to execute the second proprietary module 118.k. The execution path 112 may also include other instructions in addition to instructions 202 and instructions 204, for example, instructions to execute a third open-source module or a third proprietary module.

The instructions 202 to execute the first open-source module 116.k may involve the boot manager 110 providing an input 206 to the first open-source module 116.k. The input 206 may include a command to execute the first open-source module 116.k. The input 206 may also include one or more parameters required or recommended for the execution of the first open-source module 116.k, e.g., an indication that the machine 100 is being booted. Alternatively, the input 206 may include no parameters. In response to the input 206, the first open-source module 116.k may provide an output 208 to the boot manager 110. The output 208 may indicate that the first open-source module 116.k successfully executed or that the first open-source module 116.k failed to execute. For example, the output 208 may be a Boolean value, where TRUE indicates that the first open-source module 116.k successfully executed and FALSE indicates that the first open-source module failed to execute, or vice versa.

The instructions 204 to execute the second proprietary module 118.k may involve the boot manager 110 providing an input 210 to the second proprietary module 118.k. The input 210 may include a command to execute the second proprietary module 118.k. The input 210 may also include one or more parameters required or recommended for the execution of the second proprietary module 118.k, e.g., an indication that the machine 100 is being booted. Alternatively, the input 210 may include no parameters. In response to the input 210, the second proprietary module 118.k may provide an output 212 to the boot manager 110. The output 212 may indicate that the second proprietary module 118.k successfully executed or that the second proprietary module 118.k failed to execute. For example, the output 212 may be a Boolean value, where TRUE indicates that the second proprietary module 118.k successfully executed and FALSE indicates that the first open-source module failed to execute, or vice versa.

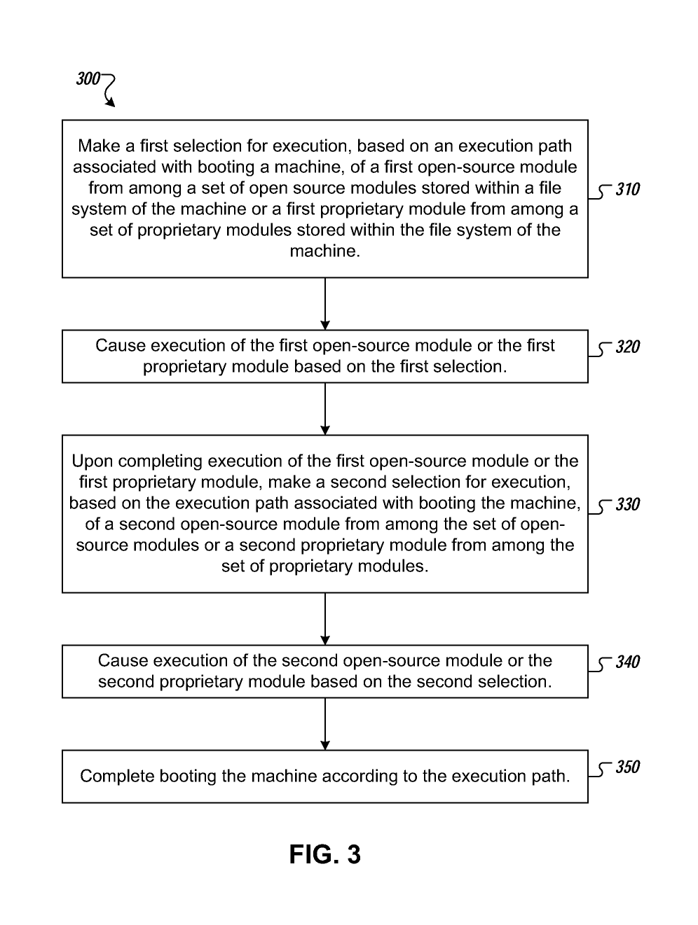

FIG. 3 illustrates an example process 300 by which a machine (e.g., machine 100) may be booted using a firmware file system.

The process 300 begins at step 310, where the boot manager (e.g., boot manager 110) makes a first selection for execution, based on an execution path (e.g., execution path 112) associated with booting the machine, of a first open-source module from among a set of open-source modules (e.g., set of open-source modules 116.1-n) stored within a file system (e.g., file system 114) of the machine or a first proprietary module from among a set of proprietary modules (e.g., set of proprietary modules 118.1-n) stored within the file system of the machine.

In step 320, the boot manager causes execution of the first open-source module or the first proprietary module based on the first selection. In one example, the boot manager causes execution of the first open-source module or the first proprietary module by invoking the first open-source module or the first proprietary module.

In step 330, upon completing the execution (and causing the execution) of the first open-source module or the first proprietary module, the boot manager makes a second selection for execution, based on the execution path associated with booting the machine, of a second open-source module from among the set of open-source modules or a second proprietary module from among the set of proprietary modules.

In step 340, the boot manager causes execution of the second open-source module or the second proprietary module based on the second selection. In one example, the boot manager causes execution of the second open-source module or the second proprietary module by invoking the second open-source module or the second proprietary module.

In step 350, the boot manager completes booting the machine according to the execution path. The execution path may include instructions for causing execution of at least one open-source module from among the set of open-source modules (e.g., the first open-source module or the second open-source module) and instructions for causing execution of at least one proprietary module from among the set of proprietary modules (e.g., the first proprietary module or the second proprietary module). In addition, the booting module may be configured to select the open-source module(s) and the proprietary module(s) that are executed. As a result, the open-source module(s) may not select the proprietary module(s) to be executed or providing data to the proprietary module(s). Also, the proprietary module(s) may not select open-source module(s) to be executed or providing data to the open-source module(s). After step 350, the process 300 ends.

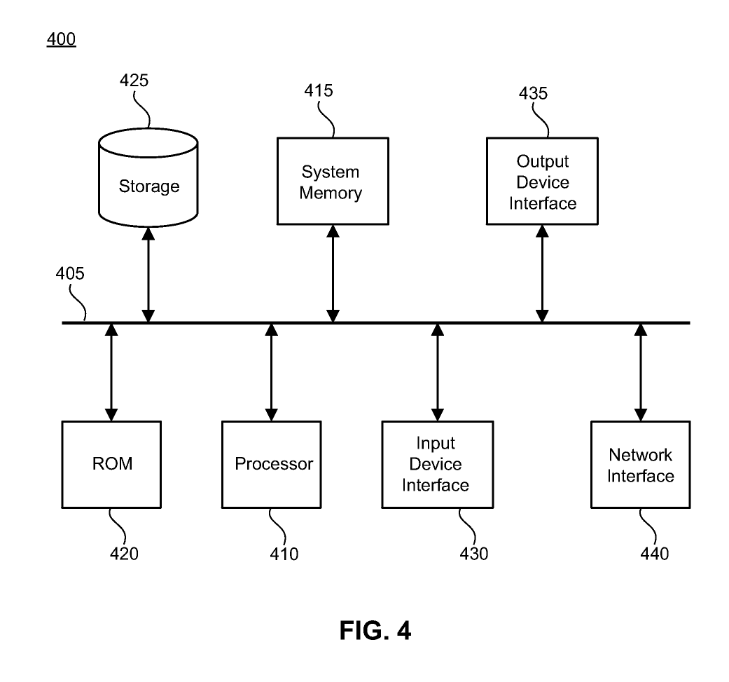

FIG. 4 conceptually illustrates an electronic system 400 with which some implementations of the subject technology are implemented. For example, the machine 100 may be implemented using the arrangement of the electronic system 400. The electronic system 400 can be a computer (e.g., a mobile phone, PDA), or any other sort of electronic device. Such an electronic system includes various types of computer readable media and interfaces for various other types of computer readable media. Electronic system 400 includes a bus 405, processing unit(s) 410, a system memory 415, a read-only memory 420, a permanent storage device 425, an input device interface 430, an output device interface 435, and a network interface 440.

The bus 405 collectively represents all system, peripheral, and chipset buses that communicatively connect the numerous internal devices of the electronic system 400. For instance, the bus 405 communicatively connects the processing unit(s) 410 with the read-only memory 420, the system memory 415, and the permanent storage device 425.

From these various memory units, the processing unit(s) 410 retrieves instructions to execute and data to process in order to execute the processes of the subject technology. The processing unit(s) can be a single processor or a multi-core processor in different implementations.

The read-only-memory (ROM) 420 stores static data and instructions that are needed by the processing unit(s) 410 and other modules of the electronic system. The permanent storage device 425, on the other hand, is a read-and-write memory device. This device is a non-volatile memory unit that stores instructions and data even when the electronic system 400 is off. Some implementations of the subject technology use a mass-storage device (for example a magnetic or optical disk and its corresponding disk drive) as the permanent storage device 425.

Other implementations use a removable storage device (for example a floppy disk, flash drive, and its corresponding disk drive) as the permanent storage device 425. Like the permanent storage device 425, the system memory 415 is a read-and-write memory device. However, unlike storage device 425, the system memory 415 is a volatile read-and-write memory, such a random access memory. The system memory 415 stores some of the instructions and data that the processor needs at runtime. In some implementations, the processes of the subject technology are stored in the system memory 415, the permanent storage device 425, or the read-only memory 420. For example, the various memory units include instructions for booting a machine using a firmware file system in accordance with some implementations. From these various memory units, the processing unit(s) 410 retrieves instructions to execute and data to process in order to execute the processes of some implementations.

The bus 405 also connects to the input and output device interfaces 430 and 435. The input device interface 430 enables the user to communicate information and select commands to the electronic system. Input devices used with input device interface 430 include, for example, alphanumeric keyboards and pointing devices (also called “cursor control devices”). Output device interfaces 435 enables, for example, the display of images generated by the electronic system 400. Output devices used with output device interface 435 include, for example, printers and display devices, for example cathode ray tubes (CRT) or liquid crystal displays (LCD). Some implementations include devices for example a touchscreen that functions as both input and output devices.

Finally, as shown in FIG. 4, bus 405 also couples electronic system 400 to a network (not shown) through a network interface 440. In this manner, the electronic system 400 can be a part of a network of computers (for example a local area network (“LAN”), a wide area network (“WAN”), or an Intranet, or a network of networks, for example the Internet. Any or all components of electronic system 400 can be used in conjunction with the subject technology.

The above-described features and applications can be implemented as software processes that are specified as a set of instructions recorded on a computer readable storage medium (also referred to as computer readable medium). When these instructions are executed by one or more processing unit(s) (e.g., one or more processors, cores of processors, or other processing units), they cause the processing unit(s) to perform the actions indicated in the instructions. Examples of computer readable media include, but are not limited to, CD-ROMs, flash drives, RAM chips, hard drives, EPROMs, etc. The computer readable media does not include carrier waves and electronic signals passing wirelessly or over wired connections.

In this specification, the term “software” is meant to include firmware residing in read-only memory or applications stored in magnetic storage or flash storage, for example, a solid-state drive, which can be read into memory for processing by a processor. Also, in some implementations, multiple software technologies can be implemented as sub-parts of a larger program while remaining distinct software technologies. In some implementations, multiple software technologies can also be implemented as separate programs. Finally, any combination of separate programs that together implement a software technology described here is within the scope of the subject technology. In some implementations, the software programs, when installed to operate on one or more electronic systems, define one or more specific machine implementations that execute and perform the operations of the software programs.

A computer program (also known as a program, software, software application, script, or code) can be written in any form of programming language, including compiled or interpreted languages, declarative or procedural languages, and it can be deployed in any form, including as a stand alone program or as a module, component, subroutine, object, or other unit suitable for use in a computing environment. A computer program may, but need not, correspond to a file in a file system. A program can be stored in a portion of a file that holds other programs or data (e.g., one or more scripts stored in a markup language document), in a single file dedicated to the program in question, or in multiple coordinated files (e.g., files that store one or more modules, sub programs, or portions of code). A computer program can be deployed to be executed on one computer or on multiple computers that are located at one site or distributed across multiple sites and interconnected by a communication network.

These functions described above can be implemented in digital electronic circuitry, in computer software, firmware or hardware. The techniques can be implemented using one or more computer program products. Programmable processors and computers can be included in or packaged as mobile devices. The processes and logic flows can be performed by one or more programmable processors and by one or more programmable logic circuitry. General and special purpose computing devices and storage devices can be interconnected through communication networks.

Some implementations include electronic components, for example microprocessors, storage and memory that store computer program instructions in a machine-readable or computer-readable medium (alternatively referred to as computer-readable storage media, machine-readable media, or machine-readable storage media). Some examples of such computer-readable media include RAM, ROM, read-only compact discs (CD-ROM), recordable compact discs (CD-R), rewritable compact discs (CD-RW), read-only digital versatile discs (e.g., DVD-ROM, dual-layer DVD-ROM), a variety of recordable/rewritable DVDs (e.g., DVD-RAM, DVD-RW, DVD+RW, etc.), flash memory (e.g., SD cards, mini-SD cards, micro-SD cards, etc.), magnetic or solid state hard drives, read-only and recordable Blu-Ray® discs, ultra density optical discs, any other optical or magnetic media, and floppy disks. The computer-readable media can store a computer program that is executable by at least one processing unit and includes sets of instructions for performing various operations. Examples of computer programs or computer code include machine code, for example is produced by a compiler, and files including higher-level code that are executed by a computer, an electronic component, or a microprocessor using an interpreter.

While the above discussion primarily refers to microprocessor or multi-core processors that execute software, some implementations are performed by one or more integrated circuits, for example application specific integrated circuits (ASICs) or field programmable gate arrays (FPGAs). In some implementations, such integrated circuits execute instructions that are stored on the circuit itself.

As used in this specification and any claims of this application, the terms “computer”, “server”, “processor”, and “memory” all refer to electronic or other technological devices. These terms exclude people or groups of people. For the purposes of the specification, the terms display or displaying means displaying on an electronic device. As used in this specification and any claims of this application, the terms “computer readable medium” and “computer readable media” are entirely restricted to tangible, physical objects that store information in a form that is readable by a computer. These terms exclude any wireless signals, wired download signals, and any other ephemeral signals.

To provide for interaction with a user, implementations of the subject matter described in this specification can be implemented on a computer having a display device, e.g., a CRT (cathode ray tube) or LCD (liquid crystal display) monitor, for displaying information to the user and a keyboard and a pointing device, e.g., a mouse or a trackball, by which the user can provide input to the computer. Other kinds of devices can be used to provide for interaction with a user as well; for example, feedback provided to the user can be any form of sensory feedback, e.g., visual feedback, auditory feedback, or tactile feedback; and input from the user can be received in any form, including acoustic, speech, or tactile input. In addition, a computer can interact with a user by sending documents to and receiving documents from a device that is used by the user; for example, by sending web pages to a web browser on a user's client device in response to requests received from the web browser.

The subject matter described in this specification can be implemented in a computing system that includes a back end component, e.g., as a data server, or that includes a middleware component, e.g., an application server, or that includes a front end component, e.g., a client computer having a graphical user interface or a Web browser through which a user can interact with an implementation of the subject matter described in this specification, or any combination of one or more such back end, middleware, or front end components. The components of the system can be interconnected by any form or medium of digital data communication, e.g., a communication network. Examples of communication networks include a local area network (“LAN”) and a wide area network (“WAN”), an inter-network (e.g., the Internet), and peer-to-peer networks (e.g., ad hoc peer-to-peer networks).

The computing system can include clients and servers. A client and server are generally remote from each other and typically interact through a communication network. The relationship of client and server arises by virtue of computer programs running on the respective computers and having a client-server relationship to each other. In some aspects of the disclosed subject matter, a server transmits data (e.g., an HTML page) to a client device (e.g., for purposes of displaying data to and receiving user input from a user interacting with the client device). Data generated at the client device (e.g., a result of the user interaction) can be received from the client device at the server.

It is understood that any specific order or hierarchy of steps in the processes disclosed is an illustration of example approaches. Based upon design preferences, it is understood that the specific order or hierarchy of steps in the processes may be rearranged, or that all illustrated steps be performed. Some of the steps may be performed simultaneously. For example, in certain circumstances, multitasking and parallel processing may be advantageous. Moreover, the separation of various system components illustrated above should not be understood as requiring such separation, and it should be understood that the described program components and systems can generally be integrated together in a single software product or packaged into multiple software products.

Various modifications to these aspects will be readily apparent, and the generic principles defined herein may be applied to other aspects. Thus, the claims are not intended to be limited to the aspects shown herein, but is to be accorded the full scope consistent with the language claims, where reference to an element in the singular is not intended to mean “one and only one” unless specifically so stated, but rather “one or more.” Unless specifically stated otherwise, the term “some” refers to one or more. Pronouns in the masculine (e.g., his) include the feminine and neuter gender (e.g., her and its) and vice versa. Headings and subheadings, if any, are used for convenience only and do not limit the subject technology.

A phrase, for example, an “aspect” does not imply that the aspect is essential to the subject technology or that the aspect applies to all configurations of the subject technology. A disclosure relating to an aspect may apply to all configurations, or one or more configurations. A phrase, for example, an aspect may refer to one or more aspects and vice versa. A phrase, for example, a “configuration” does not imply that such configuration is essential to the subject technology or that such configuration applies to all configurations of the subject technology. A disclosure relating to a configuration may apply to all configurations, or one or more configurations. A phrase, for example, a configuration may refer to one or more configurations and vice versa.

What is claimed is:

1. A system for booting a machine, the system comprising:
a boot manager configured to manage the initialization of at least one hardware component of the machine based on an execution path; and
a file system comprising one or more open-source modules and one or more proprietary modules;
wherein the boot manager is further configured to make a first selection of a first one of the one or more open-source modules or a first one of the one or more proprietary modules to be executed based on the execution path and, upon completion of execution of the first selection, the boot manager is further configured to make a second selection of a second one of the one or more open-source modules or a second one of the one or more proprietary modules to be executed based on the execution path,
wherein the one or more open-source modules do not select the one or more proprietary modules to be executed and the one or more open-source modules do not provide data to the one or more proprietary modules to be executed,
wherein the one or more proprietary modules do not select the one or more open-source modules to be executed and the one or more proprietary modules do not provide data to the one or more open-source modules to be executed, and
wherein the execution path comprises execution of at least one open-source module and at least one proprietary module.

2. The system of claim 1, wherein the at least one open-source module is configured to select an additional open-source module for execution or the at least one open-source module is configured to provide data to the additional open-source module.

3. The system of claim 1, wherein the at least one proprietary module is configured to select an additional proprietary module for execution or the at least one proprietary module is configured to provide data to the additional proprietary module.

4. The system of claim 1, wherein the system is a non-volatile storage device.

5. The system of claim 1, wherein the at least one proprietary module is configured to initialize a hardware component of the machine.

6. The system of claim 5, wherein a device driver for the hardware component of the machine comprises the at least one proprietary module.

7. The system of claim 1, wherein the at least one open-source module is configured to initialize a hardware component of the machine.

8. The system of claim 1, wherein the at least one proprietary module comprises the first one of the one or more proprietary modules or the second one of the one or more proprietary modules.

9. The system of claim 1, wherein the at least one open-source module comprises the first one of the one or more open-source modules or the second one of the one or more open-source modules.

10. The system of claim 1, wherein the at least one hardware component comprises one or more of a display device, a speaker, a microphone, a processor, a network interface, or a disk drive.

11. A machine-implemented method for booting a machine, the method comprising:
selecting a first open-source module from among a set of open-source modules stored within the machine or a first proprietary module from among a set of proprietary modules stored within the machine to be executed based on an execution path associated with booting the machine;
upon completing execution of the first open-source module or the first proprietary module, selecting a second open-source module from among the set of open-source modules or a second proprietary module from among the set of proprietary modules to be executed based on the execution path; and
completing booting the machine according to the execution path;
wherein the set of open-source modules do not select proprietary modules from among the set of proprietary modules to be executed and do not provide data to the proprietary modules,
wherein the set of proprietary modules do not select open-source modules from among the set of open-source modules to be executed and do not provide data to the open-source modules, and
wherein the execution path comprises execution of at least one open-source module from among the set of open-source modules and the execution path comprises execution of at least one proprietary module from among the set of proprietary modules.

12. The machine-implemented method of claim 11, wherein the set of open-source modules and the set of proprietary modules reside within a file system of the machine.

13. The machine-implemented method of claim 11, wherein the at least one proprietary module is configured to initialize a hardware component of the machine.

14. The machine-implemented method of claim 13, wherein a device driver for the hardware component of the machine comprises the at least one proprietary module.

15. The machine-implemented method of claim 11, wherein the at least one open-source module is configured to initialize a hardware component of the machine.

16. The machine-implemented method of claim 11, wherein the at least one proprietary module comprises the first proprietary module or the second proprietary module.

17. The machine-implemented method of claim 11, wherein the at least one open-source module comprises the first open-source module or the second open-source module.

18. A machine-readable medium for booting a machine, the machine-readable medium comprising instructions which, when executed by the machine, cause the machine to:
make a first selection for execution, based on an execution path associated with booting the machine, of a first open-source module from among a set of open-source modules stored within a file system of the machine or a first proprietary module from among a set of proprietary modules stored within the file system of the machine;
cause execution of the first open-source module or the first proprietary module based on the first selection;
upon completing causing execution of the first open-source module or the first proprietary module, make a second selection for execution, based on the execution path associated with booting the machine, of a second open-source module from among the set of open-source modules or a second proprietary module from among the set of proprietary modules;
cause execution of the second open-source module or the second proprietary module based on the second selection; and
complete booting the machine according to the execution path;
wherein the set of open-source modules do not select proprietary modules from among the set of proprietary modules to be executed and do not provide data to the proprietary modules,
wherein the set of proprietary modules do not select open-source modules from among the set of open-source modules to be executed and do not provide data to the open-source modules, and
wherein the execution path comprises causing execution of at least one open-source module from among the set of open-source modules and the execution path comprises causing execution of at least one proprietary module from among the set of proprietary modules.

19. The machine-readable medium of claim 18, wherein the instructions to cause execution of the first open-source module comprise instructions which, when executed by the machine, cause the machine to:
provide an input to the first open-source module from a boot manager of the machine, wherein the boot manager is separate and distinct from set of open-source modules and the boot manager is separate and distinct from the set of proprietary modules;
provide an output from the first open-source module to the boot manager, wherein the output indicates that the first open-source module successfully executed or that the first open-source module failed to execute.

20. The machine-readable medium of claim 19, wherein the output comprises a Boolean value.

21. The machine-readable medium of claim 18, wherein the instructions to cause execution of the first proprietary module comprise instructions which, when executed by the machine, cause the machine to:
provide an input to the first proprietary module from a boot manager of the machine, wherein the boot manager is separate and distinct from set of open-source modules and the boot manager is separate and distinct from the set of proprietary modules;
provide an output from the first open-source module to the boot manager, wherein the output indicates that the first proprietary module successfully executed or that the first proprietary module failed to execute.

22. The machine-readable medium of claim 21, wherein the output comprises a Boolean value.
